(19) United States
(12) Patent Application Publication
(10) Pub. No.: US 2006/0196189 A1
(43) Pub. Date: Sep. 7, 2006

(54) Rabbat engine

(76) Inventor: Michel Gamil Rabbat, Holiday, FL (US)

Correspondence Address: Michel G. Rabbat, 1042 Cornwall Dr., Holiday, FL, 34691, US

(21) Appl. No.: 11/072,753

(22) Filed: Mar. 4, 2005

(51) Int. Cl. F02C 3/20

(52) U.S. Cl. 60/772; 60/39.461

(57) ABSTRACT

An electric generator is made to produce Direct Current which is used to separate water by electrolysis into its component gases. These are fed into the turbine driving this Generator. Starting and/or acceleration use a fuel or a combination of fuels which are injected into the combustion chamber. Using off-the-shelf technologies in this particular engine can make mankind use clean fuels such as hydrogen right away to produce Electricity to produce motion (as in means of transport) or current for industrial production or for lighting. If a supply of hydrogen is economically available, it can be used as the starting/acceleration fuel alone or in combination with other liquid or gaseous fuels. Any suitable fuels available could be used so long as the electronic controls are set to handle them.

### REFERENCES CITED

| | | | |
|---|---|---|---|
| 5196,104 | Munday | Mar. 23, 1993 | 204/258 |
| 5733,421 | Pettigrew et al | Mar. 31, 1998 | 204/228.2 |
| 6217,713 | Lee et al | Apr. 17, 2001 | 204/164 |
| 6533,919 | Narayanan et al | Mar. 18, 2003 | 205/637 |
| 6628,005 | Nelson et al | Sep. 30, 2003 | 290/40C |
| 6641,363 | Barrett et al | Nov. 04, 2003 | 415/116 |
| 6660,417 | Nishio et al | Dec. 9, 2003 | 429/21 |
| 6672,070 | Blandetal | Jan. 6, 2004 | 60/772 |
| 6679,155 | Yaschur et al | Jan. 20, 2004 | 89/1.813 |
| 6683,389 | Geis | Jan. 27, 2004 | 290/40C |
| 6691,503 | Tiemann | Feb. 17, 2004 | 60/39.17 |
| 6705,674 | Horii et al | Mar. 16, 2004 | 297/195.1 |
| 6715,279 | Zagranski et al | Apr. 6, 2004 | 60/39.821 |
| 6724,098 | Ortega et al | Apr. 20, 2004 | 290/52 |
| 6725,643 | Paul | Apr. 27, 2004 | 60/39.162 |
| 6745,801 | Cohen, J. Perry, | Jun. 8, 2004 | 141/231 |
| | Copeman, T. Maya | | |
| 6751,940 | Paul | Jun. 22, 2004 | 60/39.162 |
| 6786,694 | Tiemann | Sep. 7, 2004 | 415/1 |
| 6813,889 | Inoue | Nov. 9, 2004 | 60/737 |
| 6829,898 | Sugishita & Hideaki | Dec. 14, 2004 | 60/772 |
| 6829,899 | Benham Jr. | Dec. 14, 2004 | 60/787 |
| 6832,485 | Sugarman et al | Dec. 21, 2004 | 60/780 |
| 6837,052 | Martling | Jan. 4, 2005 | 60/737s |

### BACKGROUND

Petroleum fuels are being used up fast as demand is increasing while supply (whether intentionally or not) is not fully matching the demand volume. Pollution is increasing as the world is increasing pollutants in order to satisfy pent up demand for products and services. The need for a cleaner atmosphere is reaching critical urgency and a power system with cleaner emissions is badly needed now. Recently, the use of hydrogen as a clean burning fuel has become trendy with very complex new technologies on the drawing boards. Economical supply of hydrogen on a world-wide grid of production, transportation and distribution is very far from being available even when such new technologies become economically competitive.

We claim that the Rabbat engine organizes existing knowledge to enable hydrogen to be supplied on the spot for the production of electricity whether in a stationary or moveable equipment. It has the advantage of being feasible in a wide range of sizes from small to mammoth, to suit all applications in industry and transport so long as water is available.

In the past many an invention has been killed because it temporarily hurt the interests of some very powerful pre-existing industries. But the Rabbat engine Uses a wide array of technologies towards a united purpose. It will produce more wealth to preexisting industries while fostering the development of fledgling ones. It is simple enough to be set into production shortly while providing opportunities for world engineers to refine it. Even petroleum producing companies and nations will welcome it because it will enable them to raise prices even further while petroleum output is decreasing. New hydrocarbon fuels will be developed more suitable for turbine systems than pistons. Among the advantages of the Rabbat engine is that rotary movement produces current that is transmitted easily and without the extra weight of transmission gears and axles to the point of need such as the electric motor driving the wheels of a vehicle. The vehicle is so much lighter than a piston or even a Wankel engine because of efficiency in dead weight. The fact, that once the electronic controls are set for a certain fuel mixture, it runs at a single standard speed unless accelerated. It keeps running at that standard speed even when the vehicle is temporarily slowed or stopped, the excess electricity being used to store up hydrogen and oxygen and to replenish the battery.

### SUMMARY OF THE INVENTION

Fuel is piezoelectrically sparked to start a turbine which produces DC. electricity that starts the electrolysis of water. Oxygen produced is compressed with air and combustion exhaust. Hydrogen is then ignited in the said turbine in the presence of oxygen. The fuel can be replenished at existing outlets and batteries maybe rejuvenated or replaced as in regular automotive engines. Water is replenished too. In this invention, sparking fuel jumpstarts the process. The main compressor is run by electricity. This permits the economical placement of the compressor instead of having it in tandem with the propulsion turbine.

This invention does not rely on producing hydrogen only. This invention does not use fuel to run a turbine electric generator all the time. This invention does not use hydrogen supplied externally to produce electric current only. This invention does not use mechanical cogs and transmission axles to transfer energy within the engine or out to drive wheels or machines. It uses electric wiring for such purposes. It uses technological knowledge in a special new set up that produces immediate application. The value of this invention lies in its systematic combination of various technologies in a new order that provides new benefits, such as the ability of the engine to be autonomous when driving wheels and to use a variety of fuels according to economic availability and varying regional circumstances. As hydrogen is not presently commonly available throughout the world at roadside stations, it uses water which available to produce its own hydrogen.

This invention does not use mechanical sequences to feed fuel and oxidizer into the combustion chamber but uses electronic controls to inject both fuels and oxidizers in appropriate set up amounts.

We drive the engine to a gas station to supply it with (1) sparking fuel (2) water. We turn on the ignition. Sparking occurs in the combustion chamber. The fuel explodes in the presence of oxidizers such as air and/or oxygen. The turbine current electrolyses heated water into hydrogen and oxygen at a constant speed. When we accelerate we feed more sparking fuel which drives the generator faster to produce hydrogen and oxygen at a faster steady speed. If we slow down by applying the brakes, current is cut of the external application (wheels for example) while the engine keeps producing hydrogen and oxygen at the same rate, for storage in gas tanks or as electricity in the battery. When we come to a final stop, we turn off the engine by cutting off electric supply to the electrolytic process.

### DESCRIPTION

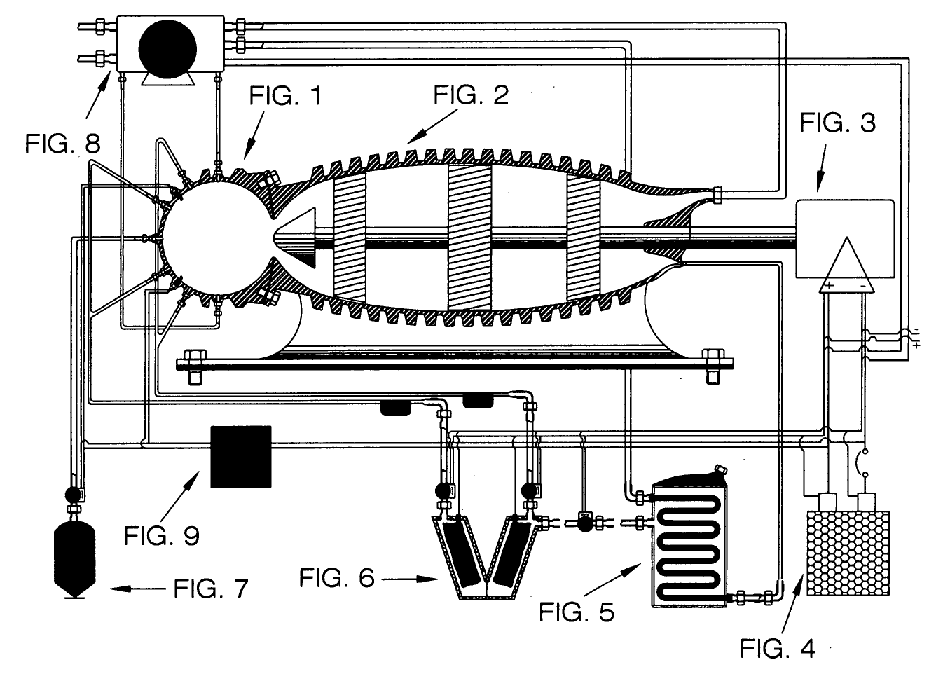

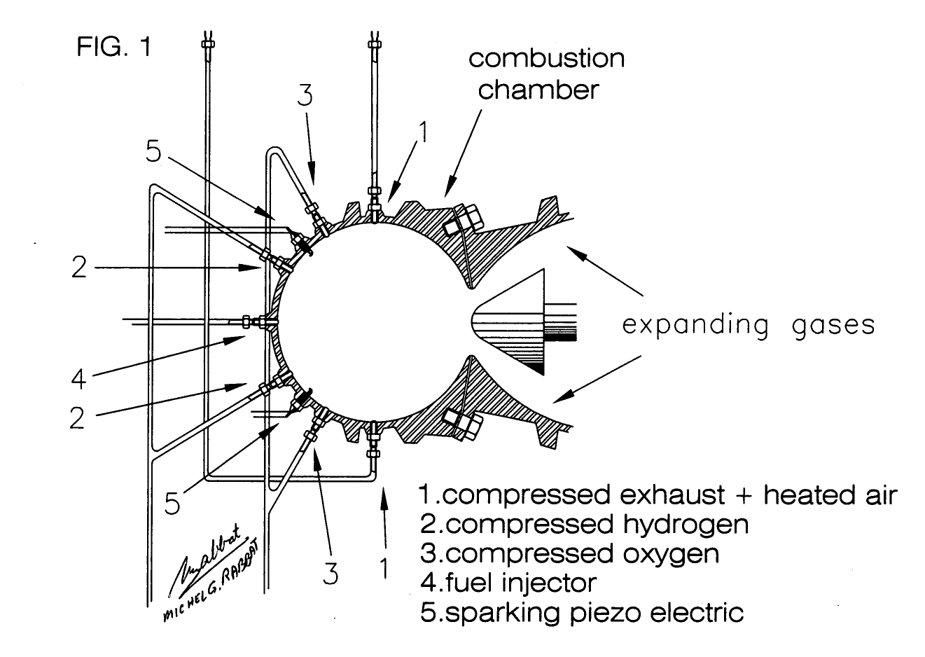

FIG. 1. Fuel injector ‘4’ injects compressed gaseous or atomized fuel into the combustion chamber where it meets a turbulence of compressed exhaust gases “1” and/or compressed hydrogen “2” and compressed oxygen “3”. A piezzo-electric spark “5” explodes the constantly monitored fuel combustible with the combustor mixture. The expanding gases that develop rush into the intake of the turbine sector.

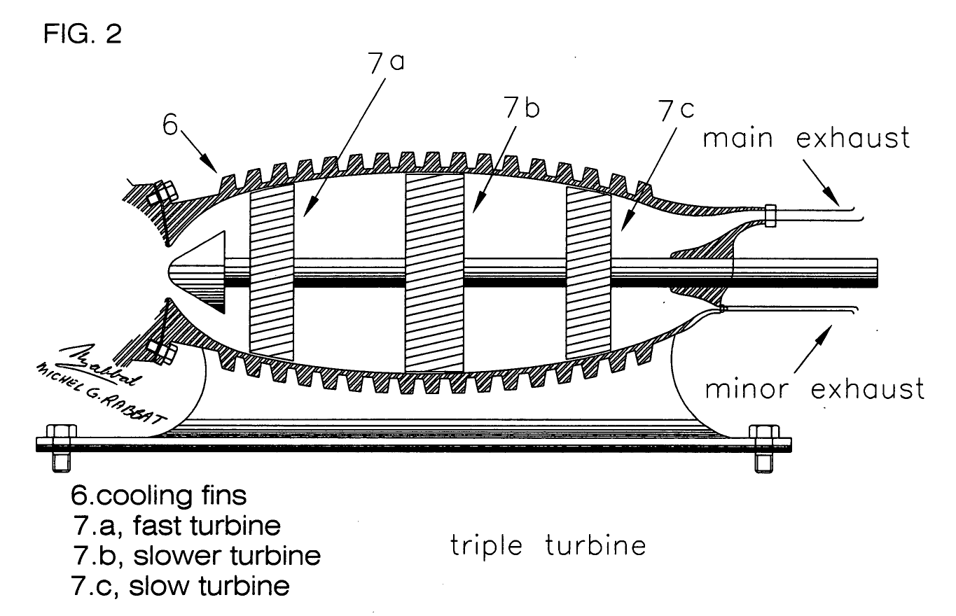

FIG. 2. The rushing gases hit the blades of a fast moving turbine “7a” that transform some of the kinetic energy of the explosion into circular motion that turns the shaft. The slowing gases hit the blades “7b” passing on to the shaft further rotary power. Finally the gases hit the blades of the last turbine on their way to the exhausts passing on some more rotary energy to the shaft. Exhausting gases and vapor are piped mainly to the main compressor while a minor portion of exhaust gases and vapor is piped to heat water in preparation for its electrolysis. The turbine sector has built-in cooling fins for heat dissipation so that the air taken in by the main compressor is usually hot.

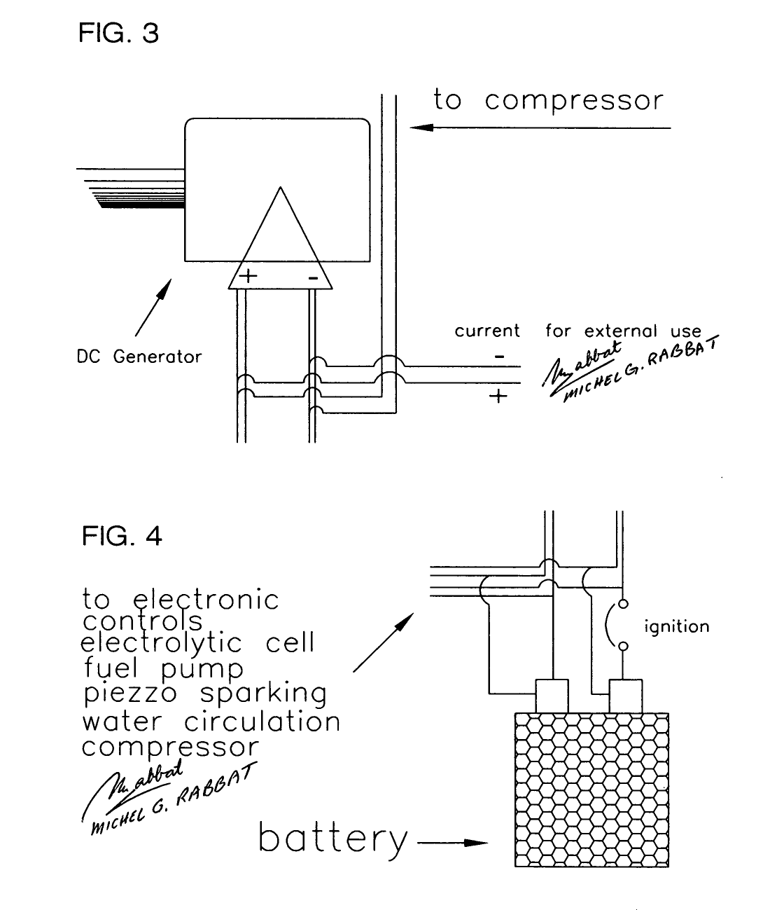

FIG. 3. This is a direct current electric generator that is nudged out of inertia when the battery-supplied ignition is switched on. It produces direct current when its shaft is rotated by the triple turbine. It supplies current to various engine processes as well as externally. The generator must be capable of easy removal for service or replacement.

FIG. 4. The battery: A suitable battery for starting ignition. It must be easy to remove and replace.

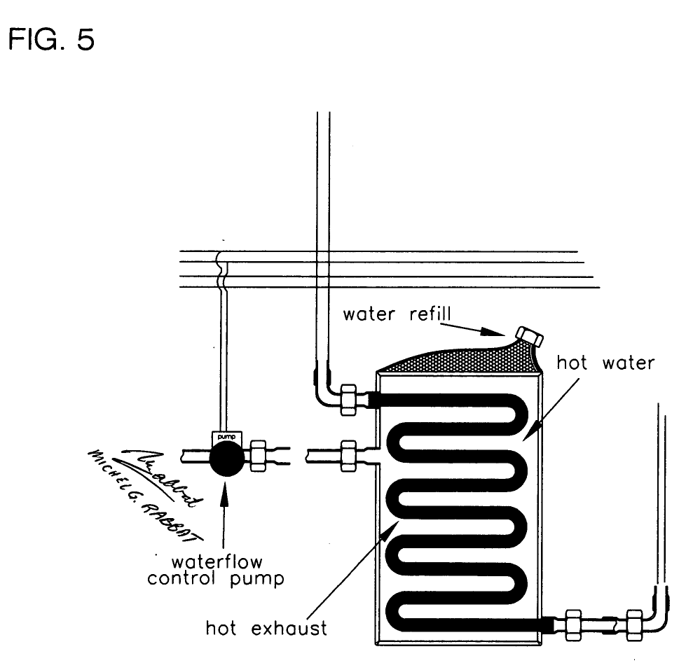

FIG. 5. This is a water tank with an opening to the outside to refill it with water. The water used could be distilled water at best or filtered brackish water or sea-water or plain tap-water if necessary. The tank must be made easy to disconnect, remove and replace for service. Its water is heated by piping carrying hot exhaust which then exit to the main compressor. The heated water exits the tank to a water-flow control pump that regulates water flow to the electrolysis apparatus as sensors deem necessary.

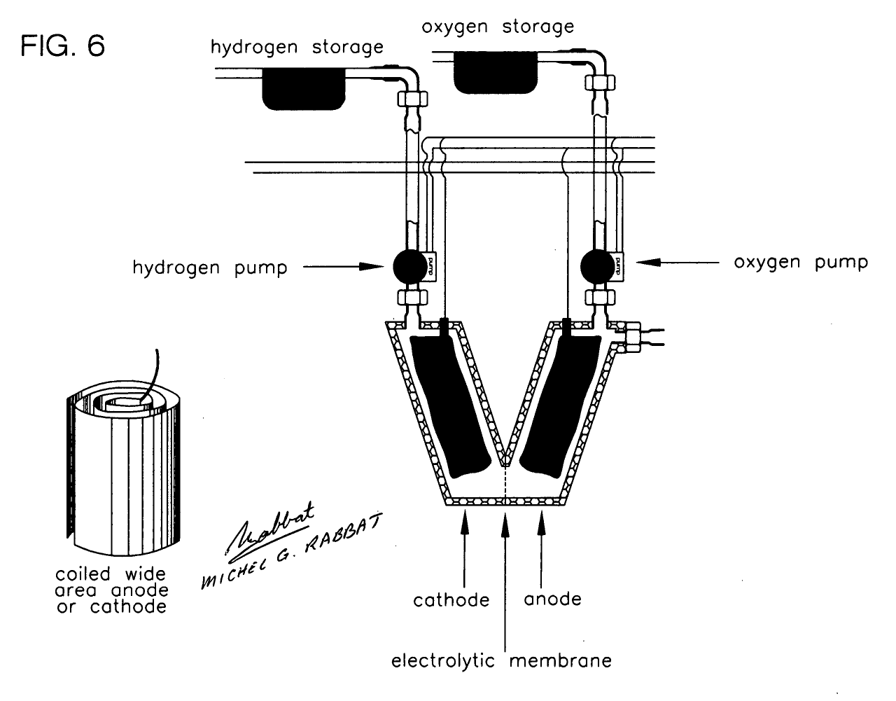

FIG. 6. It is an aqueous electrolysis cell for the generation of hydrogen and oxygen It is composed of an electrolysis container having an anode chamber and a cathode chamber connected to each other via an electrolysis membrane. An anode and a cathode having permeability to gas and water are fitted in their respective chambers and connected to the direct current thru their respective terminals. Wide area anode and cathode coiled in order to save space (see side detail) dip into the heated water supplied from the water-tank heater. Water is slightly acidified with H2SO4 for ionization catalysis. The current is supplied by the generator. A gas compressor-pump is fitted to the anode exit pipe to feed hydrogen to the combustion chamber. A similar pump is fitted to the cathode exit pipe to enrich the air of the combustion chamber with oxygen. The electrolysis unit must be made easy to remove and replace for service.

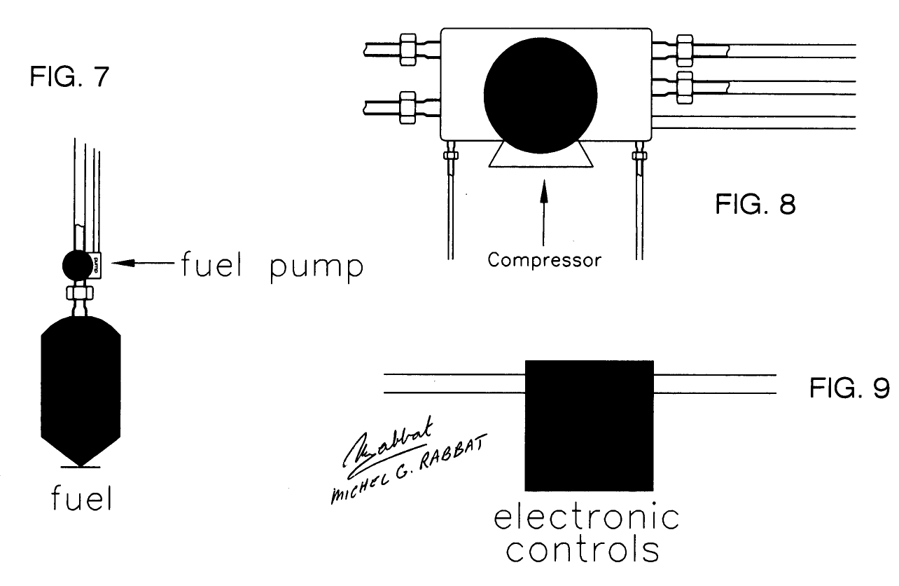

FIG. 7. The fuel tank must be of sturdy construction if compressed liquid gases are to be kept in it. A fuel pump connected to and regulated by the electronic controls and sensors, is mounted on the fuel tank. Its fuel is injected into the combustion chamber to start the engine or to produce acceleration.

FIG. 8. The main compressor receives hot air that surrounds the engine usually and injects it under appropriate pressure thru nozzle “1” into the combustion chamber for the oxidation of the fuel whenever required by the oxygen sensors and the electronic controls. When hydrogen is produced in the engine the electronic controls will blend pre-set quantities of available fuels and gases for best performance.

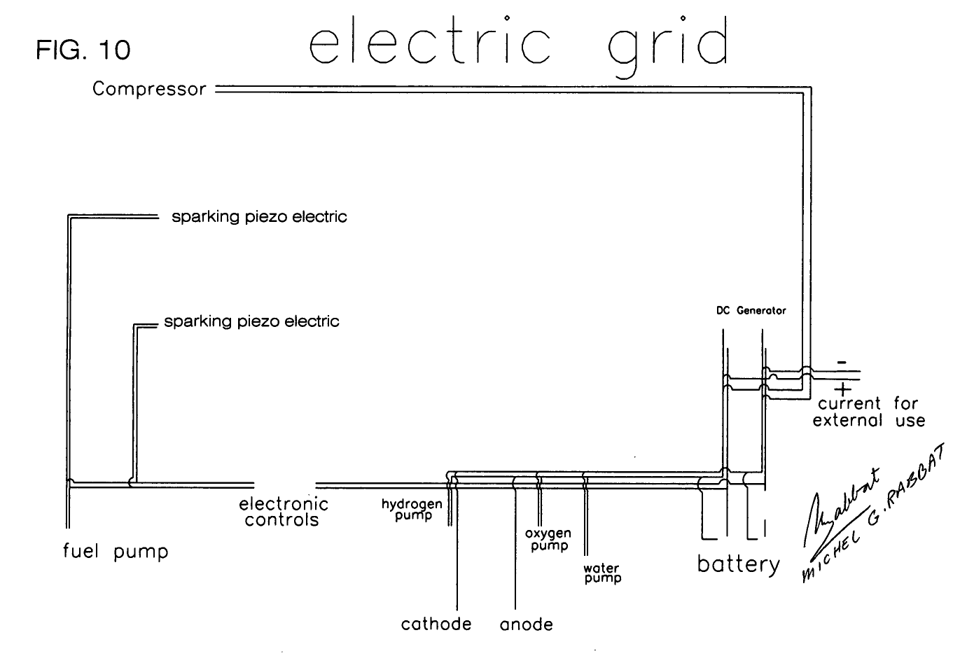

FIG. 9. The electronic controls are connected to the electric grid of the engine and to a complex grid of sensors and activators. They regulate both quantity of each item required and the timing for its release or cessation. It manages and times every aspect of delivery and combustion.

A starting fuel that explodes on being sparked is injected after being compressed or atomized into an enriched combustion chamber. The exploding gases drive a multi-speed set of turbine blades to rotate the shaft of a direct current generator. This current dissociates water to produce hydrogen and oxygen. As more hydrogen is produced, less sparking-fuel is supplied to the combustion chamber—unless acceleration requires more of it. Hot exhaust gases, including excess hydrogen, oxygen, water vapor and carbon compounds resulting from combustion, are re-injected into the compressor for recycling. Electronic controls and sensors connected to them enable this engine to constantly re-adjust the ratio of gases and fuels injected for optimal efficiency. A small fraction of hot exhaust is diverted to raise the temperature of the water tank that feeds water to the electrolytic process. Hot water speeds up the dissociation of water. The water tank and the fuel tank are connected to gauges and are separately open to the outside for fill-up.

The Rabbat Engine is organized sequentially to use available fuels to start a constant combustion not intermittently exploding pistons. This is the technology that propels rockets. The exploding gases enter a multiple turbine to maximize the power of expanding gases into a rotary movement that drives an electric generator. This is known technology but our engine does not stop there. It does not just use externally supplied fuel to generate electricity ad infinitum. It uses starting electricity into the electrolysis cycle which will be the main supplier of energy henceforth.

1. We claim that the Rabbat engine uses available technologies in a certain sequential combination to produce a mechanical and economical advantage.
Compressed hydrogen may be supplied as the sparking-fuel.
Compressed hydrocarbon gases may be supplied as the sparking-fuel.
Hydrocarbon liquids may be atomized as the sparking-fuel.
Atomized alcohols may be supplied as the sparking-fuel.
Coal-derived gases may be used as the sparking-fuel.
Shale-derived liquids and gases may be used as the sparking-fuel.
Various combinations of the above and their enrichment with hydrogen may be used as a sparkingfuel.
Distilled lake or river water, brackish water or sea-water may be used for electrolysis.
Melted snow or ice may be used for electrolysis.
The Rabbat engine may be used on locomotives with electric drive pulling a train.
The Rabbat engine may be used on locomotives that supply current to individually motorized carriages in a train.
The Rabbat engine may be used in an airplane when the weight of water carried is not detrimental.
The Rabbat engine may be used to supply D.C. current which may be transformed into Alternating current as the need arises.
